(19) United States
(12) Patent Application Publication
(10) Pub. No.: US 2024/0426762 A1
(43) Pub. Date: Dec. 26, 2024

(54) Product Detection System

(71) Applicants: TE Connectivity Solutions GmbH, Schaffhausen (CH); Tyco Electronics (Shanghai) Co., Ltd., Shanghai (CN)

(72) Inventors: Qing (Carrie) Zhou, Shanghai (CN); Dandan (Emily) Zhang, Shanghai (CN); Roberto Francisco-Yi Lu, Bellevue, WA (US); Lei (Alex) Zhou, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 18/753,381

(22) Filed: Jun. 25, 2024

(30) Foreign Application Priority Data
Jun. 25, 2023 (CN) 202310755118.4

(51) Int. Cl. G01N 21/88; B07C 5/342; B07C 5/38; G01N 21/95

(52) U.S. Cl. CPC G01N 21/8851; B07C 5/342; B07C 5/38; G01N 21/95; G01N 2021/8887

(57) ABSTRACT

A product detection system includes a cabinet having an upper cabinet and a lower cabinet, a product detection device installed in the upper cabinet and detecting a quality of a product, and a control device installed in the lower cabinet and electrically connected to the product detection device. The product detection device includes a product conveying device conveying a product and a plurality of imaging devices arranged at different positions in a conveying direction of the product. The imaging devices capture images of the product from a plurality of different orientations. The control device includes a quality judgment module determining whether a quality of the product is qualified based on the captured images.

### CROSS-REFERENCE TO RELATED APPLICATION

This application claims the benefit of the filing date under 35 U.S.C. § 119(a)-(d) of Chinese Patent Application No. 202310755118.4, filed on Jun. 25, 2023.

### FIELD OF THE INVENTION

The present invention relates to a product detection system and, more particularly, to a product detection system for detecting the quality of injection molded products.

### BACKGROUND

The quality of injection molded products (such as connector shells) is typically manually inspected. The efficiency and quality of such manual inspection, however, is not high.

### SUMMARY

A product detection system includes a cabinet having an upper cabinet and a lower cabinet, a product detection device installed in the upper cabinet and detecting a quality of a product, and a control device installed in the lower cabinet and electrically connected to the product detection device. The product detection device includes a product conveying device conveying a product and a plurality of imaging devices arranged at different positions in a conveying direction of the product. The imaging devices capture images of the product from a plurality of different orientations. The control device includes a quality judgment module determining whether a quality of the product is qualified based on the captured images.

### BRIEF DESCRIPTION OF THE DRAWINGS

Features of the present invention will become apparent by describing in detail exemplary embodiments thereof with reference to the accompanying drawings, in which:

FIG. 1 shows an illustrative perspective view of a product detection system according to an exemplary embodiment of the present invention;

FIG. 2 shows an illustrative perspective view of a product detection system according to an exemplary embodiment of the present invention when viewed from one direction, where an upper cabinet is removed to show an internal product detection device;

FIG. 3 shows an illustrative perspective view of a product detection system according to an exemplary embodiment of the present invention when viewed from another direction, where the upper cabinet is removed to show the internal product detection device; and

FIG. 4 shows an illustrative perspective view of a product detection device according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided to convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

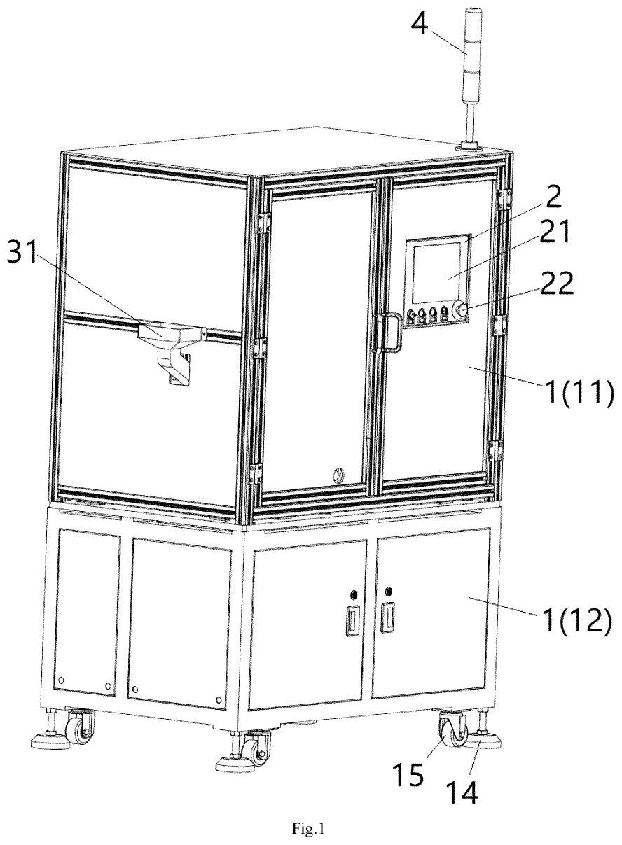

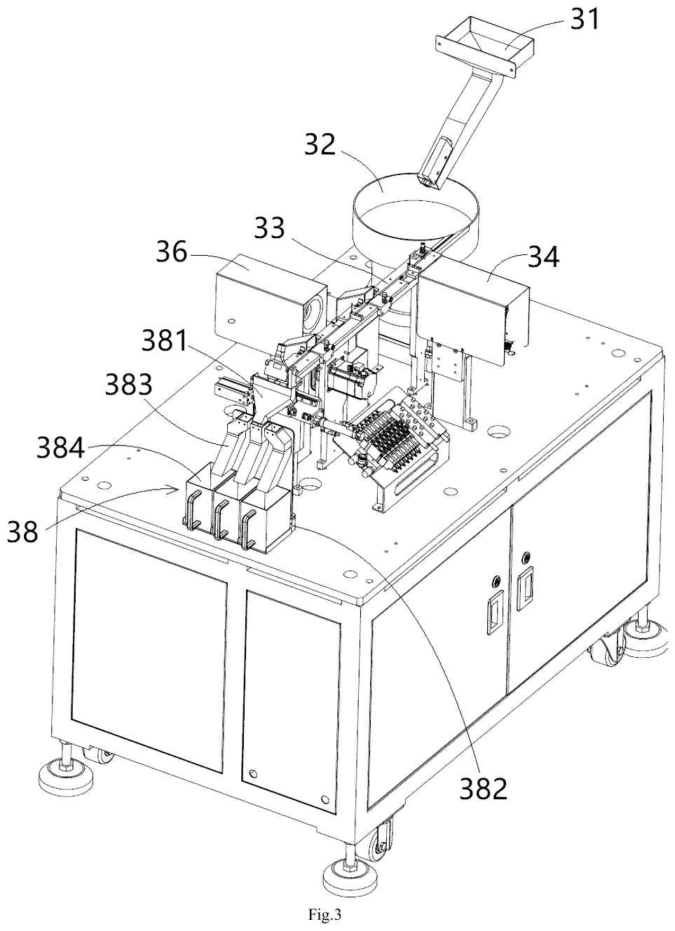

As shown in FIGS. 1-4, in an exemplary embodiment of the present invention, a product detection system is disclosed. The product detection system includes a cabinet 1, a product detection device 3, and a control device 5.

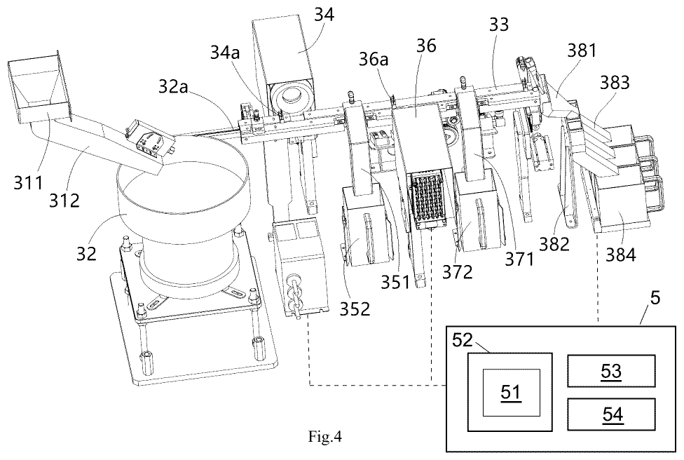

The cabinet 1 includes an upper cabinet 11 and a lower cabinet 12. The product detection device 3 is installed in the upper cabinet 11 to detect the quality of the product. The control device 5 is installed in the lower cabinet 12 and electrically connected to the product detection device 3. The control device 5 is shown schematically in FIG. 4; dashed lines in FIG. 4 indicate schematic connections between the control device 5 and components of the product detection system for the exchange of signals as described herein.

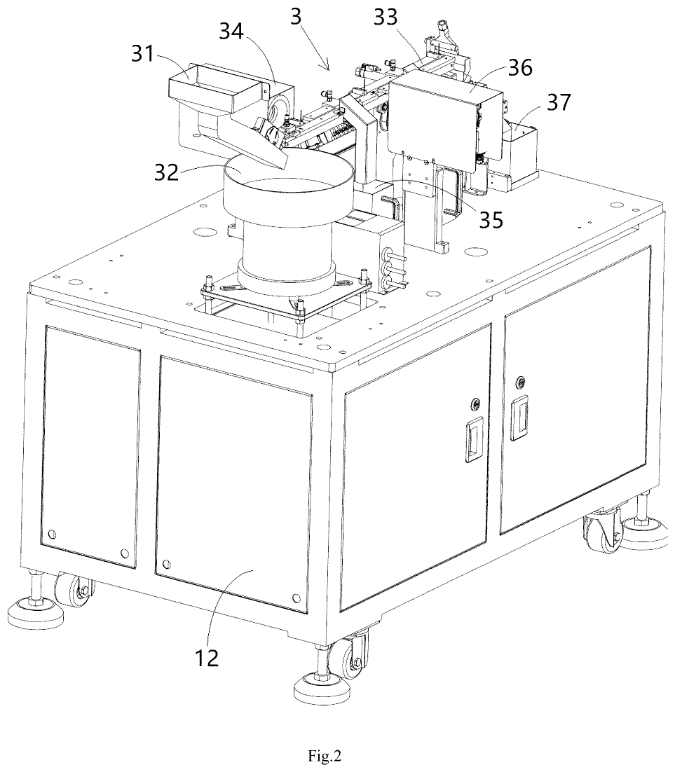

As shown in FIGS. 2-4, the product detection device 3 includes a product conveying device 33 and multiple imaging devices 34 and 36. The product conveying device 33 is used to transport the detected product (for example, an injection molded shell of a connector or other injection molded products). Multiple imaging devices 34 and 36 are arranged at different positions along the conveying direction of the product, used to capture images of the detected product from multiple different orientations.

The control device 5 includes a quality judgment module 51, which is used to determine whether the quality of the detected product is qualified based on the captured product images. The quality judgment module 51 can be a functional module that combines software and hardware, such as an algorithm program running on a PLC or industrial computer.

As shown in FIGS. 1 to 4, in the illustrated embodiments, multiple imaging devices 34 and 36 include a first imaging device 34, which is used to capture a first image of the detected product from a first orientation. The quality judgment module 51 is suitable for judging whether the quality of the detected product is qualified based on the first image captured of the product.

As shown in FIG. 4, the control device 5 further comprises a storage device 52, which can be a functional module combining software and hardware, and an identification device 54, which can also be a functional module combining software and hardware. The control device 5 may be a controller and has a processor 53 that performs the various functions of the control device 5 described herein. There are various quality judgment modules 51 corresponding to different products stored in the storage device 52. In an embodiment, the storage device 52 is a non-transitory computer-readable medium capable of storing computer instructions thereon that are executable by the processor 53. The storage device 52 stores various different product codes corresponding to various different products and various different quality judgment modules 51 corresponding to various different products. The identification device 54, which is performed by the processor 53 executing algorithms stored on the storage device 52, is used to identify the quality judgment module 51 corresponding to the product based on the first image captured. After identifying the quality judgment module 51, the control device 5 uses the identified quality judgment module 51 to determine whether the product quality is qualified.

As shown in FIGS. 2 and 4, in the illustrated embodiments, the product detection system further comprises a first waste recycling device 35. The first waste recycling device 35 is installed downstream of the first imaging device 34 for recycling unqualified products. When the quality judgment module 51 determines that the quality of the detected product is unqualified based on the first image captured, the control device controls the first waste recycling device 35 to recycle the unqualified product from the product conveying device 33.

As shown in FIG. 4, in the illustrated embodiments, the product detection system further includes a first sensor 34a, which is provided on the product conveying device 33 to detect whether the product has been conveyed to the first detection station corresponding to the first imaging device 34. When the first sensor 34a detects that the product has been transported to the first detection station, the first sensor 34a sends a first trigger signal to the control device 5. When the control device 5 receives the first trigger signal, the control device 5 sends a first control signal for capturing the first image of the product to the first imaging device 34.

As shown in FIG. 4, in the illustrated embodiments, the first waste recycling device 35 comprises a first discharge channel 351, a first guiding device, and a first waste recycling bin 352. The first discharge channel 351 is fixed to the product conveying device 33 and connected to the product conveying channel of the product conveying device 33. The first guiding device is used to guide unqualified products from the product conveying channel to the first discharge channel 351. The first waste recycling bin 352 is located below the outlet of the first discharge channel 351, and is used to receive unqualified products output from the first discharge channel 351.

As shown in FIGS. 1 to 4, in the illustrated embodiments, multiple imaging devices 34 and 36 further include a second imaging device 36, which is located downstream of the first waste recycling device 35 for capturing a second image of the detected product from a second orientation different from the first orientation. The quality judgment module 51 is suitable for judging whether the quality of the detected product is qualified based on the second image of the captured product.

As shown in FIGS. 2 and 4, in the illustrated embodiments, the product detection system further includes a second waste recycling device 37. The second waste recycling device 37 is located downstream of the second imaging device 34 for recycling unqualified products. When the quality judgment module 51 determines that the quality of the detected product is unqualified based on the second image captured, the control device 5 controls the second waste recycling device 37 to recycle the unqualified product from the product conveying device 33.

As shown FIG. 4, in the illustrated embodiments, the product detection system further includes a second sensor 36a, which is provided on the product conveying device 33 to detect whether the product has been conveyed to the second detection station corresponding to the second imaging device 36. When the second sensor 36a detects that the product has been transported to the second detection station, the second sensor 36a sends a second trigger signal to the control device 5. When the control device 5 receives the second trigger signal, the control device 5 sends a second control signal for capturing a second image of the product to the second imaging device 36.

As shown in FIG. 4, in the illustrated embodiments, the second waste recycling device 37 comprises a second discharge channel 371, a second guide device, and a second waste recycling bin 372. The second discharge channel 371 is fixed to the product conveying device 33 and connected to the product conveying channel of the product conveying device 33. The second guiding device is used to guide unqualified products from the product conveying channel to the second discharge channel 371. The second waste recycling bin 372 is located below the outlet of the second discharge channel 371 to receive unqualified products output from the second discharge channel 371.

In the illustrated embodiments, the product detection system further includes a qualified product recycling device, which is located downstream of the product conveying device 33 for recycling qualified products. When the quality judgment module 51 determines that the quality of the detected product is qualified based on the captured images, the control device 5 controls the qualified product recycling device to recycle qualified products from the product conveying device 33.

As shown in FIG. 4, in the illustrated embodiments, the qualified product recycling device 38 includes a conical guide device 381, multiple discharge channels 383, and multiple qualified product recycling bins 384. The conical guide device 381 is movably installed on the product conveying device 33 and its inlet is connected to the outlet of the product conveying device 33. Multiple discharge channels 383 are arranged side by side to receive products output from the outlet of the conical guide device 381. Multiple qualified product recycling bins 384 are arranged side by side and located below the outlets of multiple discharge channels 383, respectively, to receive products output from the outlets of multiple discharge channels 383. The outlet of the conical guide device 381 can be moved to any one of multiple different positions that are respectively docked with the inlets of multiple discharge channels 383, in order to guide the qualified products sequentially into multiple discharge channels 383.

When the conical guide device 381 is docked with one discharge channel 383 and the qualified product recycling bin 384 corresponding to the one discharge channel 383 is already filled with qualified products, the control device 5 controls the conical guide device 381 to move to the position where it is docked with another discharge channel 383 to input the qualified products into another qualified product recycling bin 384 corresponding to another discharge channel 383.

As shown in FIG. 4, in the illustrated embodiments, the qualified product recycling device 38 further includes a bracket 382, and multiple discharge channels 383 are fixed side by side to the bracket 382.

The product detection system further includes a product supply device for supplying the detected products to the product conveying device 33. In the illustrated embodiments, the product supply device comprises a supply hopper 31 and a vibrating tray 32, as shown in FIGS. 2-4. The supply hopper 31 includes an inlet portion 311 located outside the upper cabinet 11 and an outlet portion 312 located inside the upper cabinet 11. The vibrating tray 32 is used to receive products output from the outlet portion 312 of the supply hopper 31 and transport the received products to the product conveying device 33 through vibration.

In the illustrated embodiments, the product conveying device 33 has a product conveying channel extending along a straight line, and the inlet of the product conveying channel is docked with the outlet 32a of the vibrating tray 32. The vibrating tray 32 transports the product to the inlet of the product conveying channel of the product conveying device 33 through vibration.

As shown in FIG. 1, the product detection system further comprises a control panel 2, which is set on the upper cabinet. The control panel 2 includes a human-machine interaction interface 21 and multiple control buttons 22. The human-machine interaction interface 21 is used to input information to the product detection system; the multiple control buttons 22 are used to control the start and stop of the product detection system.

When the product code input through human-computer interaction interface 21 is a product code of a new product that is not stored in the storage device 52, it is necessary to input the sample image of the new product and the corresponding quality judgment module 51 through human-computer interaction interface 21.

As shown in FIG. 1, in the illustrated embodiments, the product detection system further includes a status display light 4, which is installed on the top of the upper cabinet 11 to display the working status of the product detection system. When the product detection system is in a normal state, the control device 5 controls the status display light 4 to display a first color, for example, green. When the product detection system is in a faulty state, the control device 5 controls the status display light 4 to display a second color that is different from the first color, such as red or yellow.

As shown in FIG. 1, in the illustrated embodiments, retractable support legs 14 and wheels 15 are installed on the bottom of the cabinet 1. When the supporting legs 14 extend, the cabinet 1 is supported on the ground by the supporting legs 14. When the supporting legs 14 retract, the cabinet 1 is supported on the ground by the wheels 15 to be able to move freely on the ground through the wheels 15.

In an exemplary embodiment of the present invention, the product detection device 3 further includes a display for displaying images captured by multiple imaging devices 34 and 36, as well as the judgment results of the quality judgment module 51.

The following will refer to FIGS. 1-4 to briefly illustrate the working process of the product detection system shown in the diagram. The working process mainly includes the following steps:
S10: Input the product code to the product detection system through the human-computer interaction interface 21;
S20: Check if the input product code has been stored in the memory of the control device 5. If the result is yes, proceed to step S40 below; otherwise, proceed to step S30 below;
S30: Input the sample image of the product and the corresponding quality judgment module 51 to the product detection system through the human-computer interaction interface 21;
S40: Check if sensors 34a and 36a emit trigger signals. If the result is yes, proceed to step S50 below. Otherwise, continue to step S40;
S50: The control device 5 controls the imaging devices 34 and 36 to capture images of the product and identifies the quality judgment module 51 corresponding to the product based on the captured images;
S60: Based on the captured images, use the quality judgment module 51 to determine whether the quality of the product is qualified. If the judgment result is yes, the qualified product will be transported to the qualified product recycling device 38. If the judgment result is no, the unqualified product will be transported to the waste recycling device 35.

In the aforementioned exemplary embodiments of the present invention, the product detection system can automatically perform quality detection of various products, and can automatically sort qualified and unqualified products, greatly improving the quality detection efficiency of products.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A product detection system, comprising:
a cabinet including an upper cabinet and a lower cabinet;
a product detection device installed in the upper cabinet and detecting a quality of a product, the product detection device includes a product conveying device conveying a product and a plurality of imaging devices arranged at different positions in a conveying direction of the product, the imaging devices capturing images of the product from a plurality of different orientations; and
a control device installed in the lower cabinet and electrically connected to the product detection device, the control device includes a quality judgment module determining whether a quality of the product is qualified based on the captured images.

2. The product detection system according to claim 1, wherein the imaging devices include a first imaging device capturing a first image of the product from a first orientation, the quality judgment module judges whether the quality of the product is qualified based on the first image of the product.

3. The product detection system according to claim 2, wherein the control device includes:
a storage device storing a plurality of quality judgment modules corresponding to different products; and
an identification device identifying one of the quality judgment modules corresponding to the product based on the first image, and after identifying the quality judgment module, the control device uses the one of the quality judgment modules to determine whether the quality of the product is qualified.

4. The product detection system according to claim 3, further comprising a first waste recycling device downstream of the first imaging device, and when the quality judgment module determines that the quality of the product is unqualified based on first image, the control device controls the first waste recycling device to recycle the unqualified product from the product conveying device.

5. The product detection system according to claim 4, further comprising a first sensor installed on the product conveying device to detect whether the product has been conveyed to a first detection station corresponding to the first imaging device, and when the first sensor detects that the product has been transported to the first detection station, the first sensor sends a first trigger signal to the control device, the control device sends a first control signal to capture the first image of the product to the first imaging device when the control device receives the first trigger signal.

6. The product detection system according to claim 4, wherein the first waste recycling device includes:
a first discharge channel fixed to the product conveying device and communicated with a product conveying channel of the product conveying device;
a first guiding device guiding unqualified products from the product conveying channel to the first discharge channel; and
a first waste recycling bin below an outlet of the first discharge channel and receiving unqualified products output from the first discharge channel.

7. The product detection system according to claim 3, wherein the imaging devices further include a second imaging device downstream of the first waste recycling device, the second imaging device captures a second image of the product from a second orientation different from the first orientation, the quality judgment module judges whether the quality of the product is qualified based on the second image.

8. The product detection system according to claim 7, further comprising a second waste recycling device downstream of the second imaging device for recycling unqualified products, wherein when the quality judgment module determines that the quality of the detected product is unqualified based on the captured second image, the control device controls the second waste recycling device to recycle the unqualified product from the product conveying device.

9. The product detection system according to claim 7, further comprising a second sensor on the product conveying device that detects whether the product has been conveyed to a second detection station corresponding to the second imaging device, and when the second sensor detects that the product has been transported to the second detection station, the second sensor sends a second trigger signal to the control device, the control device sends a second control signal to capture a second image of the product to the second imaging device when the control device receives the second trigger signal.

10. The product detection system according to claim 7, wherein the second waste recycling device includes:
a second discharge channel fixed to the product conveying device and communicated with a product conveying channel of the product conveying device;
a second guiding device guiding unqualified products from the product conveying channel to the second discharge channel; and
a second waste recycling bin below an outlet of the second discharge channel that receives unqualified products output from the second discharge channel.

11. The product detection system according to claim 1, further comprising a qualified product recycling device downstream of the product conveying device for recycling qualified products, and when the quality judgment module determines the quality of the product based on the captured images, the control device controls the qualified product recycling device to recycle the qualified product from the product conveying device.

12. The product detection system according to claim 11, wherein the qualified product recycling device includes:
a conical guide device movably installed on the product conveying device and having an inlet connected to an outlet of the product conveying device;
a plurality of discharge channels arranged side by side for receiving products output from an outlet of the conical guide device; and
a plurality of qualified product recycling bins arranged side by side and located below a plurality of outlets of the discharge channels, respectively, for receiving qualified products output from the outlets of the discharge channels, the outlet of the conical guide device can be moved to any one of a plurality of different positions that are respectively docked with a plurality of inlets of the discharge channels to guide the qualified products sequentially into the discharge channels.

13. The product detection system according to claim 12, wherein, when the conical guide device is docked with one discharge channel and the qualified product recycling bin corresponding to the one discharge channel is already filled with the qualified products, the control device controls the conical guide device to move to a position docked with another discharge channel to input the qualified products into another qualified product recycling bin corresponding to another discharge channel.

14. The product detection system according to claim 12, wherein the qualified product recycling device includes a bracket on which a plurality of discharge channels are fixed side by side.

15. The product detection system according to claim 1, further comprising a product supply device supplying the products to the product conveying device.

16. The product detection system according to claim 15, wherein the product supply device includes:
a supply hopper having an inlet portion outside the upper cabinet and an outlet portion inside the upper cabinet; and
a vibrating tray receiving products output from the outlet portion of the supply hopper and transporting the received products to the product conveying device through vibration.

17. The product detection system according to claim 16, wherein the product conveying device has a product conveying channel that extends along a straight line, an inlet of the product conveying channel is docked with an outlet of the vibrating tray, the vibrating tray transports the products to the inlet of the product conveying channel of the product conveying device through vibration.

18. The product detection system according to claim 1, further comprising a control panel located on the upper cabinet, the control panel has a human-machine interaction interface and a plurality of control buttons, the human-machine interaction interface is used to input information to the product detection system, the control buttons are used to control a start and stop of the product detection system.

19. The product detection system according to claim 18, wherein the control device has a storage device in which a plurality of different product codes corresponding to different products and a plurality of quality judgment modules corresponding to different products are stored, and when the product code input through the human-computer interaction interface is a product code of a new product that is not stored in the storage device, a sample image of the new product and a quality judgment module corresponding to the new product is input through the human-computer interaction interface.

20. The product detection system according to claim 1, wherein a plurality of retractable supporting legs and a plurality of wheels are installed at a bottom of the cabinet, and when the supporting legs are extended, the cabinet is supported by the supporting legs, and when the supporting legs are retracted, the cabinet is supported by the wheels and movable by the wheels.
